(19) United States
(12) Patent Application Publication
(10) Pub. No.: US 2005/0108403 A1
(43) Pub. Date: May 19, 2005

(54) Method, system, and program for transmitting packets

(75) Inventors: Vivek Jaiswal, Bangalore (IN); Kannan Babu Ramia, Bangalore (IN); Vipin Goel, Bangalore (IN)

Correspondence Address: KONRAD RAYNES VICTOR & MANN LLP, Suite 210, 315 S. Beverly Drive, Beverly Hills, CA, 90212, US

(73) Assignee: Intel Corporation

(21) Appl. No.: 10/715,737

(22) Filed: Nov. 17, 2003

(51) Int. Cl. G06F 15/16

(52) U.S. Cl. 709/227; 709/230

(57) ABSTRACT

Provided are a method, system, and program for transmitting packets between a plurality of end user systems and one server. In response to receiving an initial packet from an initiating end user system, communication is made with the server to establish a network session and obtain a network session identifier. An entry is added to a data structure associating a connection with the end user system and the network session identifier. In response to receiving a data packet from one transmitting end user system, the data structure is processed to determine the network session identifier associated with the connection to the transmitting end user system. The data packet is communicated from the transmitting end user system to the server using the network session corresponding to the network session identifier.

### BACKGROUND OF THE INVENTION

1. Field of the Invention

The present invention relates to a method, system, and program for transmitting packets.

2. Description of the Related Art

In order to access a network, such as the Internet, a computer user may use a modem to transmit data to an Internet Service Provider (ISP) over a standard telephone line. The end user may transmit packets of data over the standard telephone line to a Point of Presence (POP) system administered by the ISP or switch vendor using the Point-to-Point Protocol (PPP). The PPP protocol establishes a point-to-point link from the user computer modem terminating in the ISP system. The POP system would then transmit communications from the user modem over another network, such as an Ethernet network, Asynchronous Transfer Mode (ATM) network, Frame Relay network, to the ISP server which enables communication over the Internet or other destination network. The computer user's modem would transmit Internet Protocol (IP) packets encapsulated in PPP packets to the POP system. End user data communications on the phone line may initially be directed to a voice switch. If the communication over the phone line is voice, then the voice switch would transmit the communication to a switched telephone network; otherwise, if the communication is data, then the PPP communication would be directed to the POP system. Alternatively, voice and data may initially be transmitted to the POP system, and the POP system would forward voice communications to the voice switch. During initialization, the ISP server would negotiate the connection with the end user modem and assign an IP address for the end user modem to use for communicating with the ISP server and destination network, such as the Internet.

Upon receiving a PPP packet encapsulating an IP packet from the end user computer, the POP system may encapsulate the PPP packet in a Layer Two Tunneling Protocol (L2TP) packet, which may then be encapsulated in a (User Datagram Protocol) UDP packet, which may then further be encapsulated within an IP packet and then transmitted over an Ethernet or ATM network to the ISP server. The ISP server would then unwrap the top level IP packet to access the UDP packet therein, which is further processed to access the L2TP packet therein, which is further processed to access the PPP packet, which is yet further processed to access the underlying IP packet originating from the end user computer. The ISP may then forward the IP packet over the Internet or other network. When the ISP receives an IP packet to return to the end user computer (using the IP address assigned to the end user computer), the ISP server would wrap that IP packet in a PPP packet, then further wrap that within an L2TP packet, which is yet further wrapped within a UDP packet which is finally wrapped within an IP packet transmitted back to the POP system. The POP system would then have to unwrap the IP packet to access the UDP packet, then unwrap the UDP packet to access the L2TP packet, and then further unwrap the L2TP packet to access the PPP packet which the POP system would then return to the end user modem over the PPP link.

### BRIEF DESCRIPTION OF THE DRAWINGS

Referring now to the drawings in which like reference numbers represent corresponding parts throughout:

FIGS. 1 and 6 illustrate network computing environment in which embodiments of the invention are implemented;

FIGS. 2, 3, 4, and 5 illustrate operations to transmit packets in the network computing environment described with respect to FIG. 1;

FIGS. 7, 8, and 9 illustrate operations to transmit packets in the network computing environment described with respect to FIG. 6; and

FIG. 10 illustrates an architecture that may be used with the components in the network computing embodiments described with respect to FIGS. 1 and 6.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

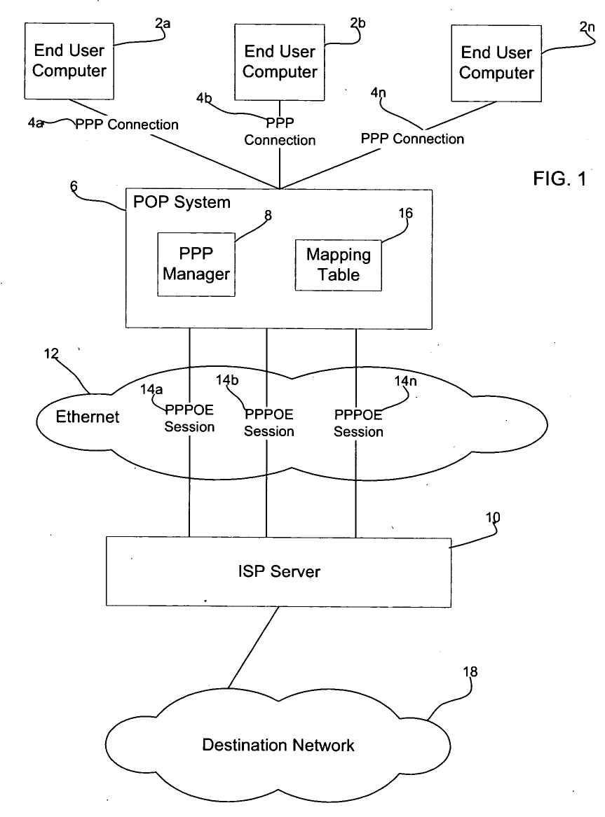

FIG. 1 illustrates a network computing environment in which aspects of the invention may be implemented. A plurality of end user computers 2a, 2b. . . 2n each communicate over a separate PPP connection 4a, 4b. . . 4n, using the PPP protocol, terminating in a Point-of-Presence (POP) system 6. The PPP connections 4a, 4b. . . 4n may comprise standard telephone lines or wireless telephone communication links, e.g., cellular communication. The end user computers 2a, 2b. . . 2n may comprise any user computing system known in the art, such as a workstation, desktop computer, laptop, handheld computer, telephony device, server, etc., having a modem (not shown) to communicate over standard telephone lines or airwaves. The POP system 6 may comprise any computing device suitable for implementing a POP system. The POP system 6 includes a PPP manager 8, which comprises the program code to manage the transmission of the PPP communications between the end user computers 2a, 2b. . . 2n and an ISP server 10 over a network 12, such as an Ethernet network, e.g., Gigabit Ethernet, etc. The ISP server 10 may comprise a server used to enable end user computers to communicate with nodes on a destination network 18, such as the Internet.

In certain embodiments, the PPP manager 8 establishes a Point-to-Point Protocol Over Ethernet (PPPOE) session 14a, 14b. . . 14n for each end user PPP connection 4a, 4b. . . 4n to transmit PPP packets between the end users 2a, 2b. . . 2n and the ISP server 10 over the Ethernet 12 as separate PPPOE sessions 14a, 14b. . . 14n. The PPP manager 8 maintains a mapping table 16 providing an association of a port identifier (ID) on the POP system 6, which comprises a logical number of a PPP connection 4a, 4b. . . 4n at the POP system 6, and a PPPOE session identifier (ID) of the PPPOE session on which the PPP packet received at the port is transmitted to the ISP server 10. The POP system 6 uses the mapping table 10 to determine the PPPOE session 14a, 14b. . . 14n on which a PPP packet received from an end user computer 2a, 2b. . . 2n on a port will be transmitted and to determine the port to use to transmit a PPP packet received through a PPPOE session 14a, 14b. . . 14n.

The ISP server 10 may negotiate for the link initialization with the end user computers 2a, 2b. . . 2n, authenticate the end user computers 2a, 2b. . . 2n, and assign an IP address to the end user computers. Further, upon receiving PPP packets transmitted as part of a PPPOE session, the ISP server 10 may access the IP packet within the PPP packet and then transmit that IP packet over a destination network 18, which may comprise the Internet.

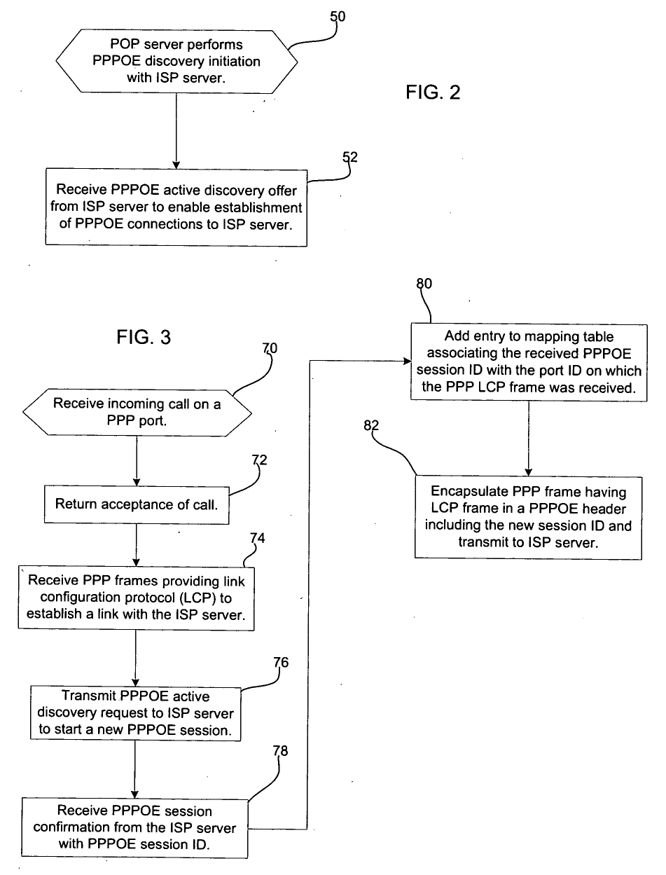

FIGS. 2, 3, 4, and 5 illustrate operations performed by the PPP manager 8 in the POP system 6 to relay communications between the end user computers 2a, 2b. . . 2n and the ISP server 10 in accordance with described embodiments. With respect to FIG. 2, the POP system 6 during initialization would perform (at block 50) PPPOE discovery initiation with the ISP server 10. In response, the POP system 6 receives (at block 52) a PPPOE active discovery offer from the ISP server 10, which enables the POP system 6 to thereafter establish PPPOE sessions with the ISP server 10 over the Ethernet 12.

With respect to FIG. 3, upon receiving (at block 70) an incoming call on a new PPP connection 4a, 4b. . . 4n port, the POP system 6 returns (at block 72) acceptance of the call. Subsequently, the POP system 6 would receive (at block 74) PPP frames providing a link configuration protocol (LCP) to establish a link with the ISP server 10. In response, the POP system 6 transmits (at block 76) a PPPOE active discovery request to the ISP server 10 to start a new PPPOE session for the PPP connection 4a, 4b. . . 4n of the received new call. In response, the POP system 6 receives (at block 78) from the ISP server 10 a PPPOE session confirmation with a new PPPOE session ID, e.g., 14n. The POP system 6 then adds (at block 80) an entry to the mapping table 16 associating the received PPPOE session ID with the port ID on which the PPP LCP frame was received. The POP system 6 also encapsulates (at block 82) the PPP frame having the LCP frame in a PPPOE header including the new session ID and transmits this PPPOE packet including the LCP frame to the ISP server 10. The ISP server 10 would then respond to this LCP frame to the end user computer to negotiate a connection.

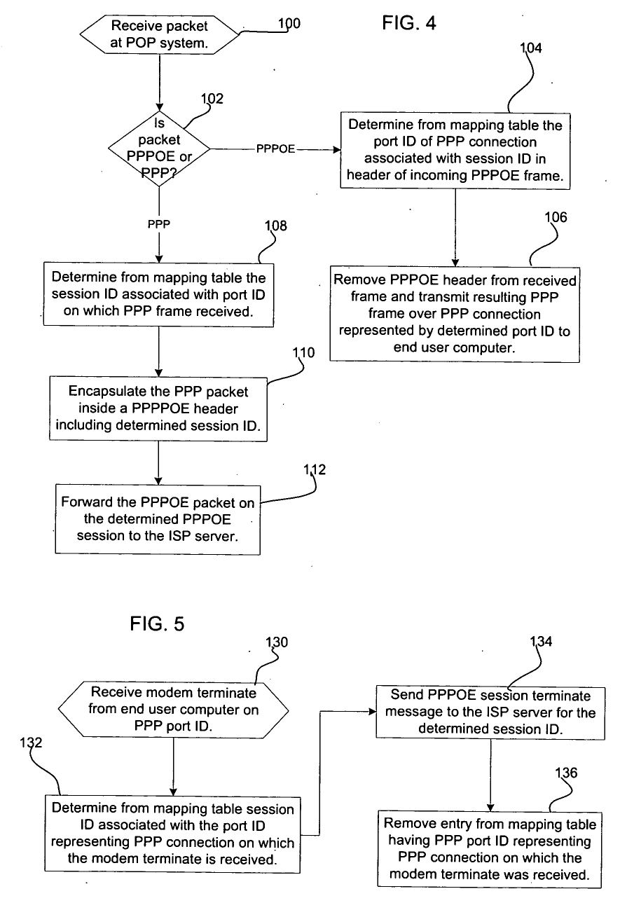

With respect to FIG. 4, after a PPPOE session is established for a new PPP connection, the POP system 6 would receive (at block 100) packets from either the end user computer 2a, 2b. . . 2n or the ISP server 10. If (at block 102) the packet is on a PPPOE session 14a, 14b. . . 14n from the ISP server 10, then the POP system 6 determines (at block 104) from the mapping table 16 the port ID of the PPP connection 4a, 4b. . . 4n associated with the session ID in the header of the incoming PPPOE frame. The PPPOE header is removed (at block 106) from the received frame and the resulting PPP frame is transmitted over the PPP connection 4a, 4b. . . 4n represented by the determined port ID to the target end user computer 2a, 2b. . . 2n. If (at block 102) the packet is a PPP packet from one end user computer 2a, 2b. . . 2n, then the POP manager 8 determines (at block 108) from the mapping table 16 the session ID associated with port ID representing the connection 4a, 4b. . . 4n on which the PPP frame received. The PPP frame is encapsulated (at block 110) inside a PPPOE header including the determined session ID and the PPPOE packet is forwarded (at block 112) on the determined PPPOE session to the ISP server 10.

With respect to FIG. 5, the PPP connection 4a, 4b. . . 4n, receives (at block 130) a modem termination from one end user computer. The POP system 6 would then determine (at block 132) from the mapping table 16 the PPPOE session ID associated with the port ID representing the PPP connection 4a, 4b. . . 4n upon which the modem terminate is received. The POP system 6 then sends (at block 134) a PPPOE session terminate message to the ISP server 10 for the determined session ID and removes (at block 136) the entry from the mapping table 16 having the port ID representing the PPP connection 4a, 4b. . . 4n on which the modem terminate frame was received.

With the described embodiment of FIGS. 1-5, the POP system and ISP system avoid having to encapsulate the PPP packet received from or directed to the end user computers in multiple link layers to transmit over the Ethernet, such as in L2TP, UDP, and IP additional layers. Instead, the PPP packet is encapsulated within a PPPOE header and then transmitted over the Ethernet, thereby avoiding the need for additional layer translation at the POP system and ISP server nodes.

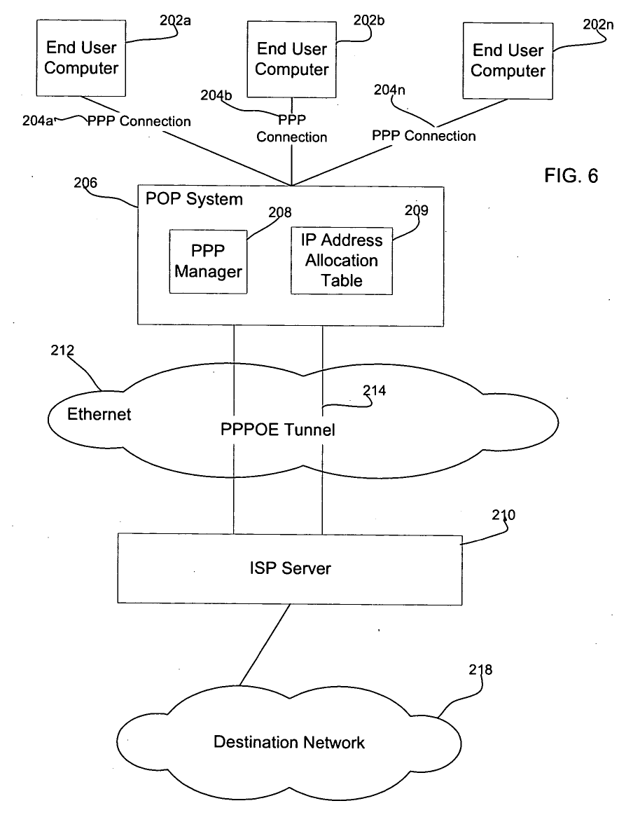

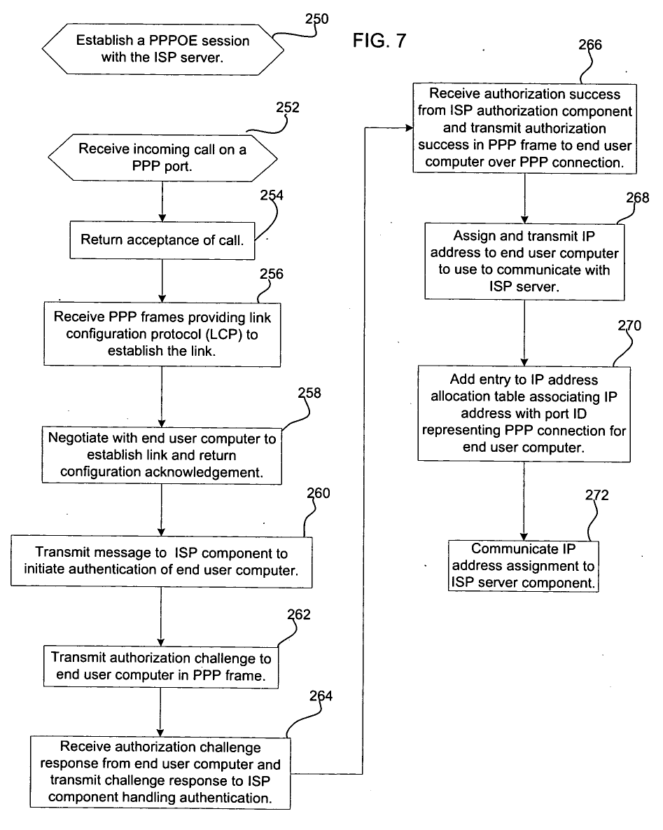

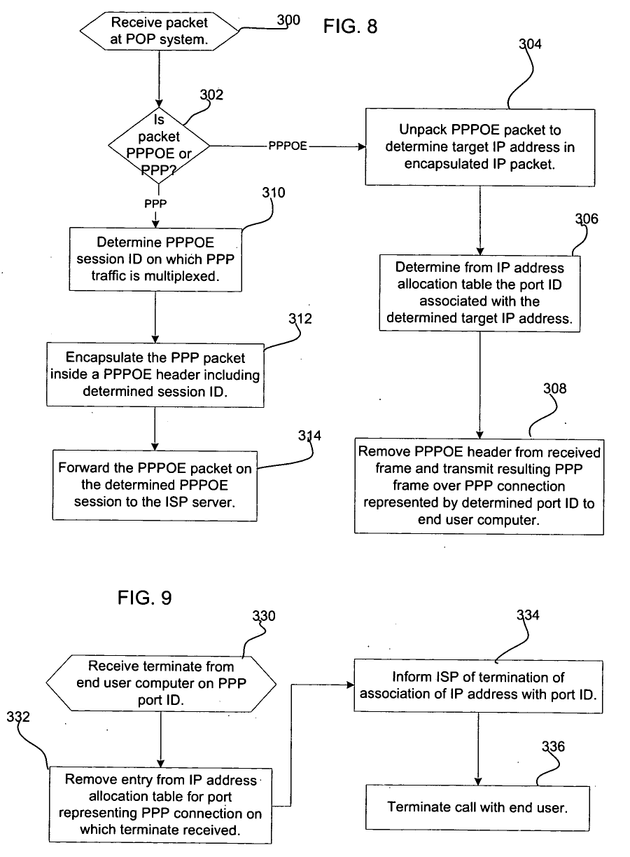

FIG. 6 illustrates an additional embodiment of a POP system relaying communications between end user computers and an ISP server. FIG. 6 shows system components, such as end user computers 202a, 202b. . . 202n, PPP connections 204a, 204b. . . 204n, a POP system 206, Ethernet 212, ISP server 210, and destination network 218 that may comprise the same components 2a, 2b. . . 2n, 4a, 4b. . . 4n, 6, 12, 10, and 18, respectively, described with respect to FIG. 1. Additionally, the POP system 206 includes a PPP manager 208 that handles communications with respect to the PPP connections 204a, 204b. . . 204n in the manner described below with respect to FIGS. 7 and 8. An IP address allocation table 209 provides an allocation of IP addresses to the end user computers 202a, 202b. . . 202n, including an IP address pool and IP address to session number mapping. Further, in FIG. 6, the PPP manager 208 may assign IP addresses to end user computers 202a, 202b. . . 202n and then transmit PPP packets from end user computers 202a, 202b. . . 202n through a single PPPOE tunnel 214 over Ethernet 212 encapsulated with the PPPOE header of the PPPOE tunnel 214. In this way, the PPP manager 208 functions as a multiplexer to transmit packets from different PPP connections 204a, 204b. . . 204n through a single PPPOE tunnel 214 to the ISP server 210. The ISP server 210 may then access the IP packet from the PPP frames encapsulated in the PPPOE header and then transmit the extracted IP packet over the destination network 218 to the target node.

FIGS. 7, 8. and 9 illustrate operations performed by the PPP manager 208 (FIG. 6). The PPP manager 208 initially establishes (at block 250) a PPPOE session with the ISP server 210 to provide the PPPOE tunnel 214 through which PPP packets from the end user computers 202a, 202b. . . 202n are communicated. Upon receiving (at block 252) an incoming call from an end user computer 202a, 202b. . . 202n on a PPP port representing a PPP connection 204a, 204b. . . 204n, the PPP manager 208 returns (at block 254) acceptance of the call to the initiating end user computer 202a, 202b. . . 202n. Upon receiving (at block 256) PPP frames including the link configuration protocol (LCP) to establish a link, the PPP manager 208 negotiations (at block 258) with the end user computer 202a, 202b. . . 202n to establish the connection 204a, 204b. . . 204n and returns configuration acknowledgement. The PPP manager 208 further transmits (at block 260) a message to an ISP component, which may comprise the ISP server 210 or some system managed by the ISP, such as a radius server, to initiate authentication of the end user computer 202a, 202b. . . 202n. The PPP manager 208 would assist with authentication by transmitting (at block 262) an authorization challenge to the end user computer 202a, 202b. . . 202n in a PPP frame. Upon receiving (at block 264) an authorization challenge response from the end user computer 202a, 202b. . . 202n, the PPP manager 208 would forward the challenge response to the ISP component handling authentication. Upon receiving (at block 266) an authorization success message from the ISP authorization component, the PPP manager 208 would transmit authorization success in a PPP frame to the end user computer 202a, 202b. . . 202n over the corresponding PPP connection 204a, 204b. . . 204n.

After the end user computer 202a, 202b. . . 202n is successfully authenticated, the PPP manager 208 would assign and transmit (at block 268) an IP address to the end user computer 202a, 202b. . . 202n to use to communicate with ISP server 210. The PPP manager 208 further adds (at block 270) an entry to the IP address allocation table 209 associating the assigned IP address with the port ID representing the PPP connection 204a, 204b. . . 204n for the end user computer 202a, 202b. . . 202n initiating the call. The IP address assignment is also communicated (at block 272) to an ISP server component.

With the described embodiments of FIGS. 6 and 7, certain operations routinely performed by the ISP server 210 may be offloaded to the POP system 206, such as the IP address allocation and the link configuration protocol negotiation with the end user computers 202a, 202b. . . 202n. Further the POP system 6 multiplexes the communications from different PPP connections 204a, 204b. . . 204n to a single PPPOE tunnel 214 to the ISP server 214.

FIG. 8 illustrates operations performed by the POP system 206 to process received packets. Upon receiving (at block 300) a data packet, if (at block 302) the packet is a PPPOE packet from the ISP server 210, then the PPP manager 208 unpacks (at block 304) the PPPOE packet to determine the target IP address in the encapsulated IP packet. As discussed, an IP packet may be encapsulated within the PPP packet. The port ID associated with the determined target IP address is determined (at block 306) from the IP address allocation table 209. The PPPOE header is removed (at block 308) from the received PPPOE frame and the resulting PPP frame is transmitted over the PPP connection 204a, 204b. . . 204n represented by the determined port ID to the end user computer 202a, 202b. . . 202n terminating at the end of the PPP connection. If (at block 302) the packet is a PPP packet from the end user computer 202a, 202b. . . 202n directed to the IP server 210, then the POP system 206 determines (at block 310) the PPPOE session ID for the PPPOE tunnel 214 on which PPP traffic is multiplexed. The PPP packet is encapsulated (at block 312) inside a PPPOE header including the determined session ID for the PPPOE tunnel 214 to form a PPPOE packet and the formed PPPOE packet is forwarded (at block 314) on the determined PPPOE session representing PPPOE tunnel 214 to the ISP server 210.

With respect to FIG. 9, the PPP connection 4a, 4b. . . 4n, receives (at block 330) an LCP termination from one end user computer. The POP system 6 would then remove (at block 332) the entry from the IP address allocation table 209 for the port representing the PPP connection 4a, 4b. . . 4n on which terminate was received. The POP system 6 further informs (at block 334) the ISP 210 of the termination of the association of the IP address with the port on which terminate was received. The call is then terminated (at block 336).

With the described implementations, packets are communicated between the ISP server and end user computer in a PPP packet. This avoids the need to encapsulate the PPP packet in different link layer protocols, such as L2TP, UDP and/or IP. Instead, a header is added to the PPP packet to allow for PPPOE communication of the PPP packet.

### ADDITIONAL EMBODIMENT DETAILS

The described embodiments for transmitting packets may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

Certain described embodiments utilized the PPP protocol for transferring packets from the end user computers over standard telephone lines. However, those skilled in the art will recognize that the described architecture may be used for additional protocols that may allow the transfer of packets between end user computers and an ISP server.

The illustrated operations of FIGS. 2, 3, 4 5, 7, 8, and 9 illustrate operations occurring in a certain order and performed by specific components. In alternative embodiments, certain operations may be performed in a different order, modified or removed, and/or performed by different components in the channel adaptor than those shown. Moreover, steps may be added to the above described logic and still conform to the described embodiments. Further, operations described herein may occur sequentially or certain operations may be processed in parallel. Yet further, operations may be performed by a single processing unit, multi-processing unit or by distributed processing units.

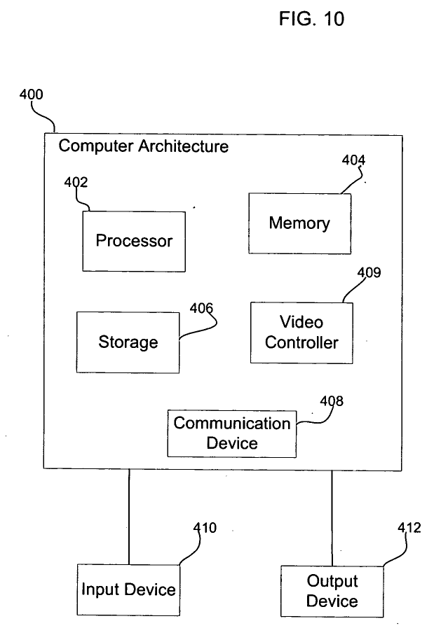

FIG. 10 illustrates one implementation of a computer architecture 400 of the network components, such as the end user computers, POP system, and ISP server shown in FIGS. 1 and 6. The architecture 400 may include a processor 402 (e.g., a microprocessor), a memory 404 (e.g., a volatile memory device), and storage 406 (e.g., a non-volatile storage, such as magnetic disk drives, optical disk drives, a tape drive, etc.). The storage 406 may comprise an internal storage device or an attached or network accessible storage. Programs in the storage 406 are loaded into the memory 404 and executed by the processor 402 in a manner known in the art. The architecture further includes a communication device 408 to enable communication with a another device. For instance, the end user computers 2a, 2b. . . 2n and POP system may have a communication device 408 comprising a modem to enable communication over a standard telephone line. Additionally, the POP system and the ISP server 10 communication device may comprise a network device, such as a network card or network controller mounted on the motherboard to enable communication over a network, such as the Ethernet. Further, the architecture may, in certain embodiments, include a video controller 409 to render information on a display monitor, where the video controller 409 may be implemented on a video card or integrated on integrated circuit components mounted on the motherboard. As discussed, certain of the network devices may have multiple network cards. An input device 410 is used to provide user input to the processor 402, and may include a keyboard, mouse, pen-stylus, microphone, touch sensitive display screen, or any other activation or input mechanism known in the art. An output device 412 is capable of rendering information transmitted from the processor 402, or other component, such as a display monitor, printer, storage, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method for transmitting packets between a plurality of end user systems and one server, comprising:
in response to receiving an initial packet from an initiating end user system, communicating with the server to establish a network session and obtain a network session identifier;
adding an entry to a data structure associating a connection with the end user system and the network session identifier;
in response to receiving a data packet from one transmitting end user system, processing the data structure to determine the network session identifier associated with the connection to the transmitting end user system; and
communicating the data packet from the transmitting end user system to the server using the network session corresponding to the network session identifier.

2. The method of claim 1, further comprising:
encapsulating the data packet from the transmitting end user system with a header including the determined network session identifier, wherein the encapsulated data packet is transmitted to the server.

3. The method of claim 1, further comprising:
in response to receiving a data packet from the server, determining one network session identifier included with the received data packet;
determining from the data structure the connection to one end user system associated with the determined network session identifier; and
transmitting the data packet on the determined connection to one end user system.

4. The method of claim 3, wherein the network session identifier is included within a header encapsulating the data packet from the server, further comprising:
removing the header and network session identifier from the data packet, wherein the extracted data packet is transmitted on the determined connection.

5. The method of claim 4, wherein the data packet received from the end user system is encapsulated in a Point-to-Point Protocol (PPP) packet and the connection with the end user system comprises a standard telephone line and wherein the data packet from the server is encapsulated in a PPP over Ethernet (PPPOE) packet having a header including the network session identifier of the PPPOE network session over which the PPPOE packet was transmitted.

6. The method of claim 1, wherein one network session identifier is obtained from the server for each connection to one end user computer.

7. The method of claim 1, wherein the server comprises an Internet Service Provider (ISP) server and wherein the end user computer communicates with the ISP server to access a network through the ISP server.

8. A method for transmitting packets between a plurality of end user systems and one server, comprising:
in response to receiving an initial packet from an initiating end user system, assigning a network address to the end user system;
adding an entry to a data structure associating a connection with the end user system and the network address assigned to the end user system;
determining one network session identifier of a network session on which data packets from multiple end user systems are transmitted to the server; and
communicating the data packet from the transmitting end user system to the server using the network session corresponding to the network session identifier.

9. The method of claim 8, further comprising:
encapsulating the data packet from the transmitting end user system with a header including the determined network session identifier, wherein the encapsulated data packet is transmitted to the server.

10. The method of claim 1, further comprising:
in response to receiving a data packet from the server, determining the network address included with the received data packet;
determining from the data structure the connection to one end user system associated with the determined network address;
transmitting the data packet on the determined connection to one end user system.

11. The method of claim 10, wherein the network session identifier is included within a header encapsulating the data packet from the server, further comprising:
removing the header and network session identifier from the data packet, wherein the extracted data packet is transmitted on the determined connection.

12. The method of claim 11, wherein the network address comprises an Internet Protocol (IP) address, wherein the data packet received from the end user system is encapsulated in a Point-to-Point Protocol (Packet) and wherein the connection between the end user system comprises a standard telephone line and wherein the data packet from the server is encapsulated in a PPP over Ethernet (PPPOE) packet having a header including the network session identifier of the PPPOE network session over which the PPPOE packet was transmitted.

13. The method of claim 1, wherein the operations of assigning the network address, adding the entry to the data structure, determining one network session identifier and communicating the data packet are performed in a system separate from the server and terminating on one end of the connections to the end user systems.

14. A system for transmitting packets between a plurality of end user systems and one server on a network, comprising:
a processing unit;
a plurality of connections capable of being used to connect with end user systems, wherein the plurality of connections are in data communication with the processing unit;
an adaptor capable of communicating with the server over the network, wherein the adaptor is in data communication with the processing unit;
program code that when executed by the processing unit causes the processing unit to perform:
(i) in response to receiving an initial packet from an initiating end user system, communicating with the server to establish a network session and obtain a network session identifier;
(ii) adding an entry to a data structure associating a connection with the end user system and the network session identifier;
(iii) in response to receiving a data packet from one transmitting end user system, processing the data structure to determine the network session identifier associated with the connection to the transmitting end user system; and
(iv) communicating the data packet from the transmitting end user system to the server using the network session corresponding to the network session identifier.

15. The system of claim 14, wherein the program code when executed causes the processing unit to further perform:
encapsulating the data packet from the transmitting end user system with a header including the determined network session identifier, wherein the encapsulated data packet is transmitted to the server.

16. The system of claim 14, wherein the program code when executed causes the processing unit to further perform:
in response to receiving a data packet from the server, determining one network session identifier included with the received data packet;
determining from the data structure the connection to one end user system associated with the determined network session identifier; and
transmitting the data packet on the determined connection to one end user system.

17. The system of claim 16, wherein the network session identifier is included within a header encapsulating the data packet from the server, wherein the program code when executed causes the processing unit to further perform:
removing the header and network session identifier from the data packet, wherein the extracted data packet is transmitted on the determined connection.

18. The system of claim 17, wherein the data packet received from the end user system is encapsulated in a Point-to-Point Protocol (PPP) packet and the connection with the end user system comprises a standard telephone line and wherein the data packet from the server is encapsulated in a PPP over Ethernet (PPPOE) packet having a header including the network session identifier of the PPPOE network session over which the PPPOE packet was transmitted.

19. The system of claim 14, wherein one network session identifier is obtained from the server for each connection to one end user computer.

20. The system of claim 14, wherein the server comprises an Internet Service Provider (ISP) server and wherein the end user computer communicates with the ISP server to access a network through the ISP server.

21. A system for transmitting packets between a plurality of end user systems and one server on a network, comprising:
a processing unit;
a plurality of connections capable of being used to connect with end user systems, wherein the plurality of connections are in data communication with the processing unit;
an adaptor capable of communicating with the server over the network, wherein the adaptor is in data communication with the processing unit;
program code that when executed by the processing unit causes the processing unit to perform:
(i) in response to receiving an initial packet from an initiating end user system, assigning a network address to the end user system;
(ii) adding an entry to a data structure associating a connection with the end user system and the network address assigned to the end user system;
(iii) determining one network session identifier of a network session on which data packets from multiple end user systems are transmitted to the server; and
(iv) communicating the data packet from the transmitting end user system to the server using the network session corresponding to the network session identifier.

22. The system of claim 21, wherein the program code when executed causes the processing unit to further perform:
encapsulating the data packet from the transmitting end user system with a header including the determined network session identifier, wherein the encapsulated data packet is transmitted to the server.

23. The system of claim 21, wherein the program code when executed causes the processing unit to further perform:
in response to receiving a data packet from the server, determining the network address included with the received data packet;
determining from the data structure the connection to one end user system associated with the determined network address;
transmitting the data packet on the determined connection to one end user system.

24. The system of claim 23, wherein the network session identifier is included within a header encapsulating the data packet from the server, wherein the program code when executed causes the processing unit to further perform:
removing the header and network session identifier from the data packet, wherein the extracted data packet is transmitted on the determined connection.

25. The system of claim 24, wherein the network address comprises an Internet Protocol (IP) address, wherein the data packet received from the end user system is encapsulated in a Point-to-Point Protocol (Packet) and wherein the connection between the end user system comprises a standard telephone line and wherein the data packet from the server is encapsulated in a PPP over Ethernet (PPPOE) packet having a header including the network session identifier of the PPPOE network session over which the PPPOE packet was transmitted.

26. An article of manufacture for transmitting packets between a plurality of end user systems and one server, wherein the article of manufacture causes operations to be performed, the operations comprising:
in response to receiving an initial packet from an initiating end user system, communicating with the server to establish a network session and obtain a network session identifier;
adding an entry to a data structure associating a connection with the end user system and the network session identifier;
in response to receiving a data packet from one transmitting end user system, processing the data structure to determine the network session identifier associated with the connection to the transmitting end user system; and
communicating the data packet from the transmitting end user system to the server using the network session corresponding to the network session identifier.

27. The article of manufacture of claim 26, wherein the operations further comprise:
encapsulating the data packet from the transmitting end user system with a header including the determined network session identifier, wherein the encapsulated data packet is transmitted to the server.

28. The article of manufacture of claim 26, wherein the operations further comprise:
in response to receiving a data packet from the server, determining one network session identifier included with the received data packet;
determining from the data structure the connection to one end user system associated with the determined network session identifier; and
transmitting the data packet on the determined connection to one end user system.

29. The article of manufacture of claim 28,, wherein the network session identifier is included within a header encapsulating the data packet from the server, further comprising:
removing the header and network session identifier from the data packet, wherein the extracted data packet is transmitted on the determined connection.

30. The article of manufacture of claim 29, wherein the data packet received from the end user system is encapsulated in a Point-to-Point Protocol (PPP) packet and the connection with the end user system comprises a standard telephone line and wherein the data packet from the server is encapsulated in a PPP over Ethernet (PPPOE) packet having a header including the network session identifier of the PPPOE network session over which the PPPOE packet was transmitted.

31. The article of manufacture of claim 26, wherein one network session identifier is obtained from the server for each connection to one end user computer.

32. The article of manufacture of claim 26, wherein the server comprises an Internet Service Provider (ISP) server and wherein the end user computer communicates with the ISP server to access a network through the ISP server.

33. An article of manufacture for transmitting packets between a plurality of end user systems and one server, wherein the article of manufacture causes operations to be performed, the operations comprising:
in response to receiving an initial packet from an initiating end user system, assigning a network address to the end. user system;
adding an entry to a data structure associating a connection with the end user system and the network address assigned to the end user system;
determining one network session identifier of a network session on which data packets from multiple end user systems are transmitted to the server; and
communicating the data packet from the transmitting end user system to the server using the network session corresponding to the network session identifier.

34. The article of manufacture of claim 33, wherein the operations further comprise:
encapsulating the data packet from the transmitting end user system with a header including the determined network session identifier, wherein the encapsulated data packet is transmitted to the server.

35. The article of manufacture of claim 33, wherein the operations further comprise:
in response to receiving a data packet from the server, determining the network address included with the received data packet;
determining from the data structure the connection to one end user system associated with the determined network address;
transmitting the data packet on the determined connection to one end user system.

36. The article of manufacture of claim 35, wherein the network session identifier is included within a header encapsulating the data packet from the server, further comprising:
removing the header and network session identifier from the data packet, wherein the extracted data packet is transmitted on the determined connection.

37. The article of manufacture of claim 36, wherein the network address comprises an Internet Protocol (IP) address, wherein the data packet received from the end user system is encapsulated in a Point-to-Point Protocol (Packet) and wherein the connection between the end user system comprises a standard telephone line and wherein the data packet from the server is encapsulated in a PPP over Ethernet (PPPOE) packet having a header including the network session identifier of the PPPOE network session over which the PPPOE packet was transmitted.

38. The article of manufacture of claim 33, wherein the operations of assigning the network address, adding the entry to the data structure, determining one network session identifier and communicating the data packet are performed in a system separate from the server and terminating on one end of the connections to the end user systems
